(19) United States
(12) Patent Application Publication
(10) Pub. No.: US 2020/0146284 A1
(43) Pub. Date: May 14, 2020

(54) METHODS FOR CONTROLLING BEEHIVE PESTS WITH FORMIC ACID-CONTAINING POLYESTERS AND RELATED COMPOSITIONS

(71) Applicant: BOARD OF TRUSTEES OF MICHIGAN STATE UNIVERSITY, East Lansing, MI (US)

(72) Inventors: Edmund J. Stark, Midland, MI (US); Patrick B. Smith, Midland, MI (US); Daniel R. Henton, Midland, MI (US); Tracy Zhang, Midland, MI (US)

(21) Appl. No.: 16/683,380

(22) Filed: Nov. 14, 2019

Related U.S. Application Data
(60) Provisional application No. 62/767,244, filed on Nov. 14, 2018.

(51) Int. Cl. A01N 37/04

(52) U.S. Cl. CPC A01N 37/04

(57) ABSTRACT

The disclosure relates to a method for treating an active beehive infested with pests. The method includes delivery of an oligomeric polyester including polyol backbone units, diacid backbone units, and formic acid capping units. Hydrolysis of the oligomeric polyester in the beehive upon exposure to environmental water to release formic acid and diacid over time, which kill the pests. The released formic acid is a relatively volatile liquid, allowing it to reach pests essentially anywhere in the hive. The diacid (such as oxalic acid) is generally a non-volatile solid, but it can be transported throughout the hive via normal bee movement within the hive, thus reaching pests beyond the initial point of application.

### CROSS REFERENCE TO RELATED APPLICATION

Priority is claimed to U.S. Provisional Patent Application 62/767,244, filed Nov. 14, 2018, the entire disclosure of which is incorporated herein by reference.

### STATEMENT OF GOVERNMENT INTEREST

None.

### BACKGROUND OF THE DISCLOSURE

### Field of the Disclosure

The disclosure relates to a method for treating an active beehive infested with pests. The method includes delivery of an oligomeric polyester including polyol backbone units, diacid backbone units, and formic acid capping units. Hydrolysis of the oligomeric polyester in the beehive upon exposure to environmental water to release formic acid and diacid over time, which kill the pests.

### Background

Approximately 20,000 known species of bees help in the pollination of flowering plants. The Food and Agriculture Organization of the United Nations estimates that of the slightly more than 100 crop species that provide 90 percent of food supplies for 146 countries, 71 are bee-pollinated (mainly by wild bees). The annual monetary value of pollination services in global agriculture could be as high as $200 billion.

A honey beehive is a warm, moist, densely populated environment inhabited by closely related individuals—the perfect setting for viruses, bacteria, fungi, protozoa and mites. In fact, colony losses and bee disappearances have occurred throughout the history of beekeeping (“apiculture”), including various honey bee syndromes in the 1880s, the 1900s, through the 1920s, the 1960s, and the 1990s, such as “disappearing disease,” “spring dwindle,” “fall dwindle,” “autumn collapse,” and “mystery disease.” In 2006, some beekeepers began reporting unusually high losses of 30-90 percent of their hives. This disappearing bee affliction was renamed “colony collapse disorder” (CCD). The main symptoms of CCD are the disappearance of the worker class, resulting in very few or no adult “worker” bees in the hive.

The world-wide honeybee industry is under severe threat from the Varroa mite. Formic acid is a known natural miticide. It is currently used in vapor phase as a hive fumigant, in liquid phase as a “flash” treatment, or formulated with other components.

The U.S. has experienced the loss of nearly one third of the honey bee colonies each year over the last decade. These large honey bee losses have also occurred globally. While the reasons for these declines are not completely understood, one primary cause is due to infestation by the mite, Varroa destructor. If left unchecked, hives that have been infected with this mite are dead within 2 years. The life cycle of the mite is about 2 weeks. A common miticide for Varroa control is a product called MITEAWAY QUICK STRIPS. It is a formulation of formic acid in a saccharide/paraffin base. When placed in a hive, it releases the volatile formic acid quickly, most of which is released within the first day or two of application. If done on a hot day, the formic acid volatilizes so quickly that its concentration in the hive is such that it not only is effective at killing mites but also bees and even the queen. Neither is it effective for Varroa control for longer than a few days. Furthermore, formic acid and/or oxalic acid, alone, are hazardous (causing burns) and are not easy or convenient to handle. Thus, there exists a market for an effective miticide that improves upon the standard treatment of formic acid towards Varroa control.

Smith et al. U.S. Publication No. 2017/0073465 is directed to a sustained release composition. the sustained release composition includes hyperbranched polymers that are polyesters that are biobased and biodegradable, and that have at least one active ingredient, which composition delivers the active ingredient over time. The active ingredients covalently bind to the polymer or are encapsulated in the polymer.

### SUMMARY

In one aspect, the disclosure relates to a method for treating an active beehive infested with pests, the method comprising: (a) providing a pesticide composition comprising a (viscous) oligomeric polyester comprising: (i) tri- or higher functional polyol backbone units (e.g., glycerol), (ii) oxalic acid (and/or other diacid) backbone units, and (iii) formic acid capping units (e.g., as terminal end groups and/or as pendant side groups); (b) inserting the pesticide composition into an active beehive infested with pests; (c) allowing the oligomeric polyester to hydrolyze over time (in particular under ambient conditions), thereby forming formic acid and oxalic acid as hydrolysis products (e.g., possibly further including polyol hydrolysis product and/or partially hydrolyzed oligomeric polyester); (d) optionally allowing at least one of the oligomeric polyester, a partially hydrolyzed product thereof, and the oxalic acid hydrolysis product (e.g., and optionally the formic acid hydrolysis product) to be transported by contact with active bees to locations in the beehive other than that where the pesticide composition was initially inserted; (e) killing pests in the beehive by exposure to formic acid; and optionally (f) killing pests in the beehive by exposure to oxalic acid, for example at interior hive surface locations other than that where the pesticide composition was initially inserted. Suitably, at least some pesticidal activity in the hive results from exposure to oxalic acid, even though formic acid can be the more effective pesticide as between the two acids. For example, in some embodiments, at least 1, 2 or 5% and/or up to 10, 20, or 30% of pest mortality can be a result of exposure to oxalic acid. The oligomeric polyester is generally a condensation product of the corresponding polyol, oxalic acid (and/or other diacids), and formic acid. The oligomeric polyester can subsequently hydrolyze upon exposure to water, for example atmospheric moisture in the beehive. The oligomeric polyester can have a branched structure, a linear structure, or a combination of both structures (e.g., a distribution of structure types resulting from polymerization). In either case, the oligomeric polyester can include formic acid units in other than end-capping positions, such as in pendant positions along linear or branched chains. The oligomeric polyester suitably is in liquid form or state at normal use temperatures. The oligomeric polyester as used herein does not have a particular upper bound in terms of molecular weight or number of monomer units, and it can be alternatively or equivalently considered as a polymeric polyester in some embodiments. The active beehive generally includes live bees and a queen therein, and it can be infested with pests such as (Varroa) mites or otherwise as the target of the pesticide composition.

Various refinements of the disclosed methods for treating an active beehive infested with pests and related compositions are possible.

In a refinement, the tri- or higher functional polyol is selected from the group consisting of glycerol, pentaerythritol, sorbitol, tris(hydroxymethyl)aminomethane, dextrose (glucose), sucrose, and combinations thereof. More generally, the polyol used to form backbone units of the oligomeric polyester can include any hydrocarbon chain (e.g., having at least 1, 2, 3 and/or up to 4, 6, 8, or 12 carbon atoms) substituted with at least three hydroxyl groups (e.g., at least 3, 4, or 5 and/or up to 4, 6, or 8 hydroxyl groups available for ester formation). In some embodiments, the polyol can include a di-functional polyol (i.e., having two hydroxyl groups).

In a refinement, the backbone units further comprise at least one of malonic acid, succinic acid, glutaric acid, adipic acid, fumaric acid, sebacic acid, and combinations thereof. More generally, a diacid used to form backbone units of the oligomeric polyester can include any hydrocarbon chain (e.g., having at least 2, 3, 4 and/or up to 4, 6, 8, or 12 carbon atoms) containing two carboxylic groups. In some alternative embodiments, the oligomeric polyester can include backbone units corresponding to one or more dicarboxylic acids, whether including oxalic acid or not.

In a refinement, the active beehive contains live bees therein, and at least 10% of the live bees survive after killing the pests by exposure to formic acid and oxalic acid. This can represent a relative survival rate of bees before and after treatment of the hive with the pesticide composition. Suitably, at least 10, 20, 30, 40, 50, 60, or 80% and/or up to 30, 50, 70, 90, or 100% of the live bees survive. In a further refinement, the live bees in the active beehive include a (single) live queen bee, and the queen bee survives after killing the pests by exposure to formic acid and oxalic acid (i.e., after treatment of the hive with the pesticide composition).

In a refinement, the pests comprise mites. In a particular refinement, the pests comprise Varroa mites and similar pests, such as tracheal mites (Acarapis woods).

In a refinement, at least 50% of the pests initially present in the beehive are killed by exposure to formic acid and oxalic acid. This can represent a relative mortality rate or relative reduction in pest population before and after treatment of the hive with the pesticide composition. Suitably, at least 50, 60, 70, 80, 90, 95, or 99% and/or up to 70, 80, 90, 98, or 100% of the pests are killed, whether (Varroa) mites or otherwise. The foregoing ranges can apply to different pest species individually and/or all pest species collectively.

In a refinement, the pesticide composition (e.g., as applied/inserted into the hive) has about 10 wt.% or less or 20 wt.% or less free formic acid, for example less than 1, 2, 3, 5, 7, 10, 15, or 20% free formic acid, whether as unreacted formic acid or a formic acid additive. In a further refinement, the pesticide composition is free from added free formic acid (e.g., free from monomeric formic acid added to the oligomeric polyester in addition to possible unreacted formic acid remaining from oligomer synthesis).

In a refinement, the pesticide composition (e.g., as applied/inserted into the hive) has about 10 wt.% or less water (e.g., less than 0.5, 1, 2, 3, 5, 7, or 10% water), which can represent condensation reaction water from oligomer formation still remaining after vacuum/evaporative removal.

In a refinement, the oligomeric polyester (e.g., as applied/inserted into the hive) has a molecular weight in a range from 200 to 5000 g/mol (e.g., at least 200, 300, 400, 500, or 600 and/or up to 800, 1000, 1200, 1500, 2000, 3000, or 5000).

In a refinement, the oligomeric polyester (e.g., as applied/inserted into the hive) has a viscosity in a range from 100 to 100,000 cP (e.g., at least 100, 200, 300, or 500 cP and/or up to 700, 1000, 2000, 3000, 5000, 10,000, 50,000, or 100,000 cP). The oligomeric polyester generally has a thick, honey-like viscosity or consistency, such that other viscosity values and/or molecular weight ranges could be appropriate.

In a refinement, (i) monomer units corresponding to the polyol are present in the oligomeric polyester in a range of 20-40 wt. % (e.g., at least 20, 25, or 30 wt. % and/or up to 30, 35, or 40 wt. %), (ii) monomer units corresponding to the oxalic acid are present in the oligomeric polyester in a range of 20-40 wt. % (e.g., at least 20, 25, or 30 wt. % and/or up to 30, 35, or 40 wt. %), and (iii) monomer units corresponding to the formic acid are present in the oligomeric polyester in a range of 30-50 wt. % (e.g., at least 30, 35, or 40 wt. % and/or up to 40, 45, or 50 wt. %). The foregoing ranges generally apply to the oligomeric polyester as it is applied/inserted into the hive (e.g., as originally formulated and prior to hydrolysis in the hive). The foregoing ranges are illustrative, being particularly representative of an oligomeric polyester formed from glycerol, oxalic acid, and formic acid. In embodiments where relatively higher molecular weight components are used for the polyol and/or a diacid other than oxalic acid, the ranges can be correspondingly wider, for example independently at least 10 wt. % and/or up to 60 wt. % of the polyol, diacid, and/or formic acid, in addition to the other noted values.

In a refinement, beehive temperature is in a range from 5° C. to 40° C. or 15° C. to 35° C. during hydrolysis of the oligomeric polyester. Suitably the temperature is at least 5, 10, 15, 20, or 25° C. and/or up to 20, 25, 30, 35, or 40° C. The temperature ranges can correspond to the external environmental temperature relative to the beehive and/or the internal beehive temperature during treatment. Similarly, the beehive temperature can represent a daily average temperature (i.e., accounting for cooler nighttime temperatures and warmer daytime temperatures) and/or a temperature range encompassing daily high/low cycles.

In a refinement, beehive relative humidity up to 80% during hydrolysis of the oligomeric polyester. Suitably the relative humidity is at least 5, 10, 20, 30, 40, or 50% and/or up to 40, 60, 70, or 80%. The relative humidity ranges generally correspond to the external environmental relative humidity relative to the beehive and/or the internal beehive relative humidity during treatment.

In a refinement, the formic acid to which the pests in the beehive are exposed when killed comprises one or more of (i) formic acid vapor and (ii) formic acid in liquid form. The formic acid vapor can be generally anywhere in the interior atmosphere of the hive. The formic acid in liquid form can be generally anywhere on an interior hive surface, whether by condensation of formic acid vapor or by bee transport. The formic acid in liquid form can include formic acid alone or in mixture or solution with another liquid, such as hydrolyzed polyol, hydrolyzed formic acid, partially hydrolyzed oligomeric polyester, and/or unhydrolyzed (original) branched oligomeric polyester in a liquid state.

In a refinement, the oxalic acid to which the pests in the beehive are exposed when killed comprises one or more of (i) oxalic acid solid, and (ii) oxalic acid in solution form. The oxalic acid in solid form can include oxalic acid crystals resulting from hydrolysis. The oxalic acid in solution form can include oxalic acid in mixture or solution with another liquid, such as water, hydrolyzed polyol, hydrolyzed formic acid, partially hydrolyzed oligomeric polyester, and/or unhydrolyzed (original) branched oligomeric polyester in a liquid state. The oxalic acid in any form can be generally anywhere on an interior hive surface as a result of bee transport, for example including hive surface locations (i) where the pesticide composition was initially inserted and (ii) other than that where the pesticide composition was initially inserted. For example, the oxalic acid can be located at a position resulting from bees tracking oxalic acid itself from the initial point of oligomeric polyester application and hydrolysis. Similarly, the oxalic acid can be located at a position resulting from bees tracking the oligomeric polyester or a partially hydrolyzed product thereof throughout the hive, which is then subsequently hydrolyzed to form oxalic acid at a location different from initial application.

In a refinement, the oligomeric polyester is transported by contact with active bees to locations in the beehive other than that where the pesticide composition was initially inserted.

In a refinement, a partially hydrolyzed product of the oligomeric polyester is transported by contact with active bees to locations in the beehive other than that where the pesticide composition was initially inserted.

In a refinement, the oxalic acid hydrolysis product is transported by contact with active bees to locations in the beehive other than that where the pesticide composition was initially inserted.

The branched oligomeric polyester generally provides a controlled, time release of formic acid and oxalic acid (or other diacid components thereof) into the beehive environment, thus providing acid levels sufficient to kill mites or other pests yet low enough to minimize or prevent injury to the bees by the acids.

In a refinement, 30% to 90% or 100% (e.g., at least 30, 40 or 50% and/or up to 60, 70, 80, 90 or 100%) of the formic acid capping units initially in the pesticide composition are released as (free) formic acid in a first 14-day period after inserting the pesticide composition into the beehive. This reflects a desirable 2-week release period to cover the brood cycle of mite pests, for example while the pests are protected in a capped bee pupa form. For the particular case of Varroa mites, such pests can infest a bee pupa while the pupa is protected by a waxy covering, which is about 12 days for worker bees. Mites within the wax covering during this period are protected from pesticide treatment within the beehive and are thus capable of re-infesting a beehive when a bee emerges from the pupa and wax covering (i.e., notwithstanding whether all other pests were previously killed in the hive). Thus, a 14-day (or longer) release period of the oligomeric polyester according to the disclosure can kill such pests that are protected during the bee pupa stage but re-emerge when the hive is still receiving pesticidal activity from a slow, controlled oligomeric polyester hydrolysis.

In a further refinement, only 30% or 50% to 70% or 80% (e.g., at least 30, 40 or 50% and/or up to 50, 60, 70 or 80%) of the total formic acid capping units released as (free) formic acid in the first 14-day period are released in the first 7 days thereof. This further reflects a desirable 2-week release period in which some, but not all, of the formic acid is released within the first week, and formic acid continues to be released in the second week of the 14-day period. This provides a continuous release of at least some formic acid throughout the 14-day period (e.g., a sufficient daily release of formic to provide pesticidal activity every day throughout the 14-day period).

In a further refinement, at least 10% (e.g., at least 10, 15, 20, 25 or 30% and/or up to 20, 30, or 40%) of the formic acid capping units initially in the pesticide composition are released as (free) formic acid in a second 7-day period subsequent to the first 14-day period after inserting the pesticide composition into the beehive. This reflects a desirable extended release profile beyond the initial two weeks and into a third week (e.g., for a total of at least 21 days over which formic acid is being released essentially continuously into the hive at effective pesticidal levels).

In a further refinement, at least 20% (e.g., at least 20, 25, 30, 35 or 40% and/or up to 30, 40, or 50%) of the formic acid capping units initially in the pesticide composition are released as (free) formic acid in a second 14-day period subsequent to the first 14-day period after inserting the pesticide composition into the beehive. This similarly reflects a desirable extended release profile beyond the initial two weeks and into third and fourth weeks (e.g., for a total of at least 28 days over which formic acid is being released essentially continuously into the hive at effective pesticidal levels).

Alternatively or additionally, the foregoing time release profiles for formic acid capping units and free formic acid can apply equally as well to corresponding release profiles for oxalic acid (or diacid) backbone units and free oxalic acid (or diacid).

While the disclosed compounds, articles, methods and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 illustrates (A) a linear oligomeric polyester and (B) a branched oligomeric polyester according to the disclosure including glycerol as polyol backbone units, oxalic acid as diacid backbone units, and formic acid as capping units. In a beehive, the exposed surface of the polyester will hydrolyze over time upon exposure to environmental water in the hive to release oxalic acid and formic acid, in which the latter can volatilize and be released into the surrounding air within the hive.

FIG. 2 is a graph of the release of formic acid from a polyester according to the disclosure when maintained at 24° C. and 75% RH over a period of about 27 days.

FIG. 3 is a graph of the release of oxalic acid form a polyester according to the disclosure when maintained at 24° C. and 75% RH over a period of about 27 days.

FIG. 4 is a graph of the release of formic acid from a polyester according to the disclosure when maintained at 34° C. and 56% RH over a period of about 20 days.

FIG. 5 is a graph of the release of formic acid form a polyester according to the disclosure when maintained at 24° C. and 75% RH as compared to a commercially available pesticide composition.

FIG. 6 is a graph of the release of formic acid form a polyester according to the disclosure when maintained at 24° C. and 75% RH when 0% and 20% of free formic acid was added to the pesticide composition according to the disclosure.

FIG. 7 is a graph of the release of formic acid from a polyester according to the disclosure when maintained at 24° C. and 56% RH when the surface to mass ratio was increased by three times.

FIG. 8 includes graphs showing the effectiveness of beehive treatment with a miticide at days 1, 21, and 43 of treatment.

FIG. 9 is a flow chart illustrating a method according to the disclosure.

### DETAILED DESCRIPTION

The disclosure relates to a method for treating an active beehive infested with pests. The method includes delivery of an oligomeric polyester including polyol backbone units, diacid backbone units, and formic acid capping units. The oligomeric polyester can be in linear and/or branched form, and it can further include formic acid groups as pendant groups along chains. The oligomeric polyester is suitably a liquid at normal use temperatures (e.g., having sufficiently low molecular weight), although a solid form at particularly low use temperatures and/or high molecular weights is possible. Hydrolysis of the oligomeric polyester in the beehive upon exposure to environmental water will release formic acid and diacid over time, which kill the pests. The released formic acid is a relatively volatile liquid, allowing it to reach pests essentially anywhere in the hive. The diacid (such as oxalic acid) is generally a non-volatile solid, but it can be transported throughout the hive via normal bee movement within the hive, thus reaching pests beyond the initial point of application.

It is desirable to release formic acid over at least a two week time period to span the brood cycle of a mite pest, in particular Varroa mites. Varroa mites have been found to be far more susceptible to acids than are honey bees. Organic acids such as oxalic acid, formic acid and lactic acid can be used as “natural miticides” or mite treatments in the hive, as they are all naturally found in honey. This disclosure relates to formic acid and other diacids (e.g., oxalic acid) that are covalently bound to natural polyols as formate and other diacid esters. The acid release rate of the resulting ester is dependent upon the rate of hydrolysis of the ester, and this rate can be controlled by various factors. The polyols are preferentially naturally derived polyols such as glycerol or longer-chain polyols derived from sugar alcohols (i.e., HOCH₂—(CHOH)ₙ—CH₂OH where n is between 1 and 4), sugars such as glucose, sucrose, xylose and fructose, high-fructose corn syrup, starches, or cellulose. These latter have the added advantage that the residue, after formate hydrolysis and evaporation of formic acid, would be natural substances already in the hive.

In a particular embodiment, the disclosure relates to an oligomeric time-release miticide composed of a low-molecular-weight polyester of oxalic acid, glycerol and formic acid. The polymer/oligomer hydrolyzes over time to slowly release formic acid and oxalic acid, both of which are natural miticides for Varroa mites. The third component, glycerol, is a natural, non-toxic component. This product slowly releases an effective dual miticide treatment that is natural and non-toxic to honey bees and humans when applied at appropriate concentrations. This time-release composition is generally a polyester in oligomeric form (i.e., relatively lower molecular weights) or polymeric form (i.e., relatively higher molecular weights) and delivers formic acid in a more controlled way than commercial products such that the concentration of formic acid is less likely to reach a concentration in a honey beehive that is toxic to the bees. These organic acid miticides are released as the polyester naturally hydrolyzes, which can be designed to occur over periods of as long as 3 to 4 weeks. The resulting degradation products are environmentally benign and biodegradable.

The oligomeric polyester is additionally advantageous from a safety standpoint. The oligomeric polyester generally does not include any free acid, whether free formic acid, free oxalic acid, or otherwise, and the oligomeric polyester is correspondingly much safer to use than either acid individually. Formic acid, for example, is about 10-fold more acidic than acetic acid, and exposure to it can cause a human to tear immediately (such as via volatile vapors) and can cause skin burns upon contact. Oxalic acid, while generally a solid and not particularly volatile unless heated, is nonetheless even more acidic than formic acid and likewise can cause injury to humans. In contrast to the free acids, the formic and oxalic ester analogs as incorporated into the oligomeric polyester do not generally have significant levels of free acid groups that are volatile or that could cause injury upon contact.

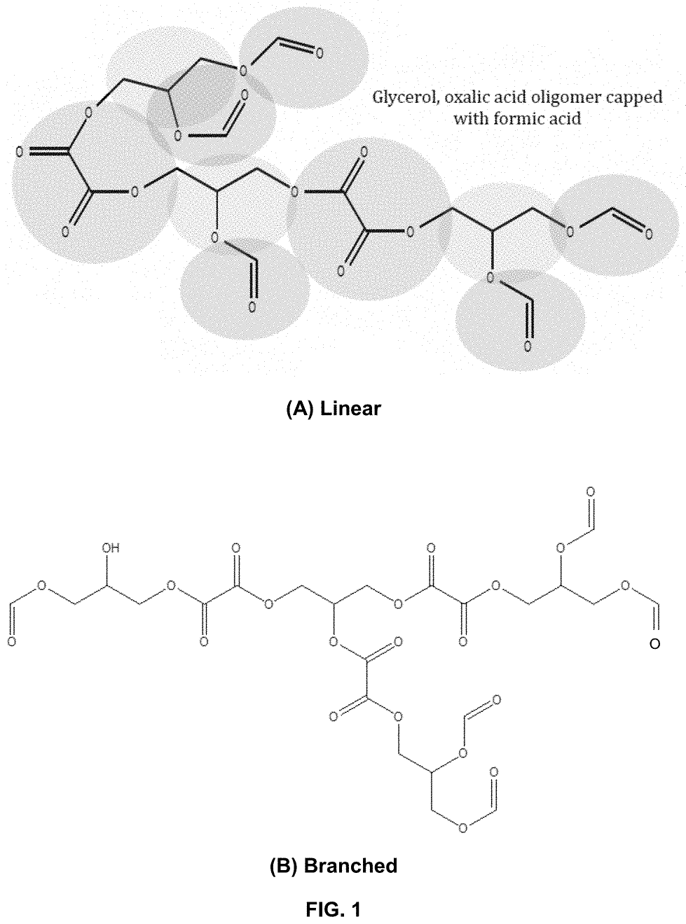

The oligomeric polyester can be formed from natural, biodegradable backbone units to which the formic acid active ingredient is covalently bonded as a capping unit. The branched structure of the oligomeric polyester increases the density of capping formic acid groups that can be incorporated into the polyester. As the polyester hydrolyzes due to the presence of natural moisture in the hive atmosphere, it releases the formic acid active in a slow, controlled rate so the dosage is maintained for a controlled level of time. As shown in FIG. 1, illustrative linear (A) and branched (B) oligomeric polyesters according to the disclosure are composed of glycerol and oxalic acid backbone units to form a linear or branched backbone structure, to which formic acid is attached as formate ester capping groups. As illustrated in both the linear and branched forms, formic acid units can be pendant units along chain lengths as well as capping units at chain terminal portions. As illustrated in FIG. 1 in the branched form (but which can be the case in both linear and branched forms), some hydroxyl groups can be unreacted. Typically, up to about 40% of the total hydroxyl groups in the original polyol monomers can be unreacted and present in the oligomer (e.g., at least 1, 2, 5, or 10% and/or up to 10, 20, 30, or 40% unreacted or free hydroxyl groups). The molar concentration of the two organic acids (i.e., which function as the miticide or other pesticide) is significantly greater than 50% since the polyester includes oxalic acid as a backbone unit in addition to formic acid as a capping unit. The other building block, glycerol, is non-toxic. The rate of hydrolytic degradation depends somewhat on temperature and humidity, but the release of the formic and oxalic acids from the polyester is generally slower and more uniform than that for formic or oxalic acid alone.

Branched and linear oligomeric polyesters more generally can be synthesized from biobased, biodegradable monomers which possess alcohol and acid functionality and are multi-functional in nature, in order to create the branched structure. Examples of multi-functional monomers include a tri-functional alcohol such as glycerol or a tetra-functional alcohol such as pentaerythritol and di-functional acids such as oxalic, succinic, adipic, fumaric and sebacic acid. Each of these acids is biobased and biodegradable and has the added advantage of being on the FDA's GRAS (“generally regarded as safe”) list. Examples of other multi-functional biobased monomers include sorbitol, dextrose (glucose), sucrose, tris(hydroxymethyl)aminomethane, malonic acid, glutaric acid, and citric acid. This list is not intended to be exhaustive, but rather illustrates representative multi-functional compounds. The mono-functional formic acid provides a capping group to the branches formed by the multi-functional alcohols and acids. The molecular weight, viscosity, and degree of branching for the branched oligomeric polyester can be controlled by selection of initial monomer stoichiometry (e.g., for polymerizations taken to completion).

### Pesticide Composition

### Oligomeric Polyester

The disclosure generally relates to a method for treating an active beehive infested with pests by inserting or otherwise delivering a pesticide composition into the beehive. As provided herein, the pesticide composition includes an oligomeric polyester.

The oligomeric polyester (or, equivalently, the “polyester”) includes polyol backbone units, diacid backbone units, and formic acid capping groups. The polyester can be prepared by reacting a polyol with a diacid, to provide a polyester polymer and further chemically bonding the formic acid groups to the polyester polymer to provide the oligomeric polyester. The oligomeric polyester resulting from the reaction of the polyol(s), the diacid(s), and the formic acid can be either linear or branched. In embodiments, the oligomeric polyester has a branched structure. In embodiments, the oligomeric polyester has a linear structure.

In embodiments, the oligomeric polyester is in liquid form. In embodiments, the oligomeric polyester has a viscosity ranging from at least about 100, 500, 1000, 5000, 10,000, 25,000 and/or up to about 5000, 10,000, 25,000, 50,000, 75,000 or 100,000 cP, for example, about 100, 500, 1000, 5000, 6000, 7000, 8000, 9000, 10,000, 15,000, 20,000, 25,000, 30,000, 40,000, 50,000, 60,000, 70,000, 75,000, 80,000, 90,000, or 100,000 cP. The oligomeric polyester can be a thick, highly viscous liquid, which can be applied to the beehives, as is. Alternatively, or additionally, the oligomeric polyester can be further formulated with, for example, free formic acid, or other ingredients desirable and applicable for use within the hives. In embodiments, the oligomeric polyester can be formulated and prepared in the form of a pull-top container, a polymer pouch, or a solid pad, which can be applied directly to the hive. In embodiments, the oligomeric polyester can be poured into a container (e.g., an open container) and placed in the hive.

In embodiments, the oligomeric polyester has a molecular weight in a range from at least about 200, 300, 500, 750, 1000, 1500 2000 and/or up to about 500, 1000, 2000, 2500, 3000, 4000 or 5000 g/mol, for example about, 200, 250, 300, 350, 400, 450, 500, 600, 700, 750, 800, 900, 1000, 1500, 2000, 2500, 3000, 3500, 4000, 4500, or 5000 g/mol.

Each of the components of the oligomeric polyester will be described in more detail, below.

### Polyol Backbone Units

As provided herein, the oligomeric polyesters of the disclosure include polyol backbone units. The polyol backbone units can be provided by reacting a polyol with the other components of the oligomeric polyester (e.g., the diacid units). In embodiments, the polyol backbone unit is a tri- or higher functional polyol backbone unit. That is, in embodiments, the polyol includes at least 3, 4, 5, 6 and/or up to 5, 6, 7, or 8 hydroxyl (—OH) groups. The polyol can generally be any polyol that includes a hydrocarbon chain having at least 3 hydroxyl groups, for example a linear or branched hydrocarbon chain. The number of carbons in the hydrocarbon chain can be at least 1, 2, 3, 4, and/or up to 4, 6, 8, or 12 carbons, for example 1, 2, 3, 4, 5, 6, 7, 8, 9, 10, 11, or 12 carbons. The hydrocarbon optionally can include one or more heteroatoms (e.g., 1, 2, 3, or 4 heteroatoms), for example nitrogen, sulfur, phosphorous, etc., such as in an amino group. Examples of suitable polyols include, but are not limited to, glycerol, sorbitol, pentaerythritol, tris(hydroxymethyl)aminomethane, xylitol, mannitol, maltitol, dextrose (glucose), sucrose, and erythritol. In embodiments, the polyol includes glycerol, pentaerythritol, sorbitol, tris(hydroxymethyl)aminomethane, or a combination thereof.

In embodiments, the polyol can include a di-functional polyol, that is, a polyol having only two hydroxyl groups. Examples of suitable di-functional polyols, also known as diols, include but are not limited to, glycols, such as ethylene glycol or propylene glycol, as well as any diol that can be prepared from a hydrocarbon chain having at least 1, 2, 3, 4 and/or up to 4, 6, 8, or 12 carbon atoms, as described for the tri-functional polyols, above.

Without intending to be bound by theory, the polyol can be added in excess when preparing the oligomeric polyester. That is, it does not limit or control the amount or rate of the oligomeric polyester that is synthesized. Furthermore, the polyol with three or more hydroxyl groups allows the oligomeric polyester to have a branched or hyperbranched structure. Accordingly, in embodiments, the oligomeric polyester is a linear polymer (i.e., has no branching or hyperbranching). In embodiments, the oligomeric polyester is a branched polymer.

In embodiments, the concentration of the polyol backbone units in the oligomeric polyester can range from at least about 20, 25, 30 and/or up to about 25, 30, 35 or 40 wt %, based on the total weight of the oligomeric polyester. For example, the concentration of the polyol backbone unit can be about 20, 21, 22, 23, 24, 25, 26, 27, 28, 29, 30, 31, 32, 33, 34, 35, 36, 37, 38, 39 or 40 wt % of the oligomeric polyester.

### Diacid Backbone Units

As provided herein, the oligomeric polyesters of the disclosure further include diacid backbone units. The diacid units can be provided by reacting any diacid, an acyl halide thereof (e.g., acyl chloride thereof), or ester thereof, with the polyol, as described above. In embodiments, the diacid includes oxalic acid, an acyl halide thereof (e.g., oxalyl chloride), or an ester thereof (e.g., dimethyl oxalate, diethyl oxalate). Free alcohols are generated during reaction with diesters (e.g., methanol, ethanol), and such alcohols are suitably removed by vacuum to drive reaction in a manner similar to water generation and removal when reacting with diacids. Residual amounts of free alcohol are suitably at levels of 1 wt. % or less (e.g., 0.01, 0.1, or 1 wt. % or less). Use of the diacid form is economically preferable relative to the generally more expensive diesters, in particular for oxalic acid and its diesters.

In embodiments, the oligomeric polyester can include diacid backbone units other than oxalic acid backbone units, such as those provided from malonic acid, succinic acid, glutaric acid, adipic acid, fumaric acid, sebacic acid, or any combination thereof. Such alternative diacid backbone units can be in place or in addition to the oxalic acid backbone units.

Without intending to be bound by theory, it is believed that the particular selection of oxalic acid (or ester thereof) enhances the degradation of the oligomeric polyester under ambient environmental conditions as it has no “spacer” (i.e., 1-12 carbon atoms) between the carboxylic acid groups. The lack of the spacer is believed to make the oxalic acid up to 100 times more acidic than normal diacids, and much more reactive. Accordingly, the resulting polymer can have much less “wasted” mass than if a diacid having a non-functional center was used. Put another way, the relative molecular weight-based density of functional groups having pesticidal activity (e.g., carboxylic groups from oxalic acid and formic acid) in the polyester is increased when using oxalic acid. Likewise, the relative molecular weight-based density of functional groups without pesticidal activity (e.g., hydrocarbon backbone from the polyol as well as longer diacids with a spacer) in the polyester is increased when using oxalic acid. Oxalic esters can advantageously provide the same benefits of oxalic acid itself, but are generally less toxic (and therefore can be handled more easily).

In embodiments, the concentration of the oxalic acid backbone units in the oligomeric polyester can range from at least about 20, 25, 30 and/or up to about 25, 30, 35 or 40 wt %, based on the total weight of the oligomeric polyester. For example, the concentration of the oxalic acid backbone unit can be about 20, 21, 22, 23, 24, 25, 26, 27, 28, 29, 30, 31, 32, 33, 34, 35, 36, 37, 38, 39 or 40 wt % of the oligomeric polyester.

### Formic Acid Capping Units

As provided herein, the oligomeric polyesters further include formic acid capping units. As used herein, the term “capping unit” means that the unit can be either terminal end groups and/or pendant side groups, by attachment to one or more hydroxyl group(s) of the polyol backbone unit, as can be seen in FIG. 1, panel (A) and panel (B).

In embodiments, the concentration of the formic acid capping units in the oligomeric polyester can range from at least about 30, 35, 40 wt % and/or up to about 40, 45, or 50 wt %, based on the total weight of the oligomeric polyester. For example, the concentration of the formic acid capping unit can be about 30, 31, 32, 33, 34, 35, 36, 37, 38, 39, 40, 41, 42, 43, 44, 45, 46, 47, 48, 49, or 50 wt % of the oligomeric polyester.

### Additional Components of the Pesticide Composition

In addition to the oligomeric polyester, the pesticide composition can also include additional components, such as, but not limited to, water and free formic acid. In cases where acid (di)esters are used as co-monomers (e.g., oxalic acid diesters), the pesticide composition can also include additional residual components such as free alcohols and/or unreacted esters,

In embodiments, the pesticide composition includes about 10 wt % of water, or less, for example at least about 0, 1, 2, 3, 4, 5 and/or up to about 4, 5, 6, 7, 8, 9 or 10 wt % water. That is, the pesticide composition can include 0, 1, 2, 3, 4, 5, 6, 7, 8, 9, or 10 wt % water. In embodiments, the pesticide composition includes about 5 wt % of free alcohol, or less, for example at least about 0, 0.1, 0.2, 0.5, 1 and/or up to about 1, 2, 3, 4, or 5 wt % free alcohol. In embodiments, the pesticide composition includes about 5 wt % of free acid diesters, or less, for example at least about 0, 0.1, 0.2, 0.5, 1 and/or up to about 1, 2, 3, 4, or 5 wt % free acid diesters.

In embodiments, the pesticide composition includes free formic acid. By “free formic acid” it is meant that formic acid can be added to the composition that contains the oligomeric polyester containing bound formic acid capping units. The free formic acid is not bound to the oligomeric polyester in any way (i.e., to the backbone or to any pendant groups). The amount of free formic acid that can be included in the composition can be 20 wt % or less, 15 wt % or less, 10 wt % or less, or 5 wt % or less. That is, the pesticide composition can include at least about 0, 1, 2, 5, 7, 10, 15 and/or up to about 7, 10, 15, 17 or 20 wt % free formic acid. In embodiments, the pesticide composition includes about 10 wt % or less of free formic acid. In embodiments, the pesticide composition is free from added free formic acid. As used herein, “free from added free formic acid” means that the pesticide composition suitable contains less than 3, 2, 1, 0.5, 0.1, or 0.01 wt % of intentionally added formic acid in addition to any formic acid added in the synthesis of the polyester. In other words, the composition includes formic acid only in the form of formic acid capping units in the oligomeric polyester. Without intending to be bound by theory, it is believed that the addition of free formic acid can increase the rate at which the formic acid and/or oxalic acid are released from the oligomeric polyester (i.e., the rate at which the oligomeric polyester degrades). This may be desirable, for example, in environments where the conditions are not suitable to spontaneous degradation of the oligomeric polyester (e.g., low humidity, etc.). Alternatively, it may be desirable to not add any free formic acid in environments where the oligomeric polyester may degrade more quickly (e.g., high humidity, etc.), in order to allow for a longer and more controlled release of the formic acid and/or oxalic acid.

### Methods of using the Pesticide Composition

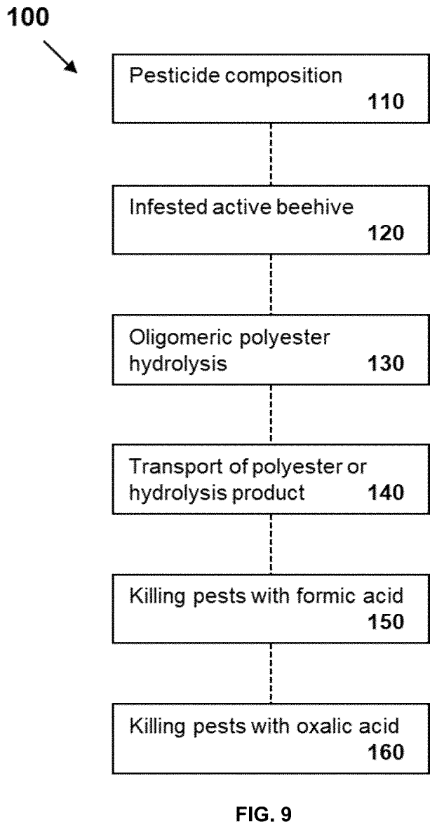

As shown in FIG. 9, the disclosure provides a method 100 for treating an active beehive infested with pests. A pesticide composition (e.g. including the oligomeric polyester) is initially prepared or otherwise provided 110, and the pesticide composition is then inserted 120 into an active beehive infested with pests. The oligomeric polyester then hydrolyzes 130 over time (e.g., as a result of exposure to ambient temperature and humidity), thereby forming formic acid and oxalic acid as hydrolysis products. Some partially hydrolyzed intermediate product of the oligomeric polyester is formed during hydrolysis and prior to release of all formic acid and oxalic acid. In some embodiments, the method further includes allowing at least one of the oligomeric polyester, a partially hydrolyzed product thereof, and the oxalic acid hydrolysis product to by transported 140 by contact with active bees to locations in the beehive other than that where the pesticide composition was initially inserted. Thus, even though the pesticide composition with corresponding oligomeric polyester might be locally applied in a particular region of the beehive, intrahive transport of the oligomeric polyester and/or its partial or full hydrolysis products can spread active ingredients throughout the hive. Even in embodiments without intrahive transport, the composition can effectively treat pests throughout the hive with the combination of formic and oxalic acids. The method includes killing pests in the beehive by exposure to formic acid 150 and oxalic acid 160. Killing of the pests in the beehive by exposure to oxalic acid 160 can occur at a variety of locations within the hive, for example at interior hive surface locations other than that where the pesticide composition was initially inserted 120 as a result of the intrahive transport mentioned above. Of course, pests in the beehive also can be killed exposure to oxalic acid 160 where the pesticide composition was initially inserted 120, for example by oligomeric polyester/oxalic acid that simply remained in place without being transported throughout the hive. While formic acid similarly can be transported throughout the hive via bee movement and contact with the polyester or hydrolysis products thereof, volatile transport of released formic acid can target pests anywhere in the hive.

In general, the pesticide composition can be used to combat any pests, but in embodiments, the pests include mites, such as Varroa mites or tracheal mites (Acarapis woods).

In embodiments, the active beehive contains live bees therein, which can transport by contact the oligomeric polyester, a partially hydrolyzed product thereof, and/or the oxalic acid hydrolysis product thereof to locations in the beehive other than where the pesticide composition was initially inserted. In embodiments, the oligomeric polyester is transported by contact with active bees to locations in the beehive other than that where the pesticide composition was initially inserted. In embodiments, a partially hydrolyzed product of the oligomeric polyester is transported by contact with active bees to locations in the beehive other than that where the pesticide composition was initially inserted. In embodiments, the oxalic acid hydrolysis product is transported by contact with active bees to locations in the beehive other than that where the pesticide composition was initially inserted.

In embodiments, the pests can be killed by exposure to the formic acid hydrolysis product. The formic acid hydrolysis product can be present in the form of a formic acid vapor and/or a formic acid in liquid form. Accordingly, in embodiments, the pests in the beehive can be killed when exposed to one or more of the formic acid vapor and the formic acid in liquid form. In embodiments, the pests can be killed by exposure to oxalic acid, for example at an interior hive surface location other than that where the pesticide composition was originally inserted. The oxalic acid hydrolysis product can be present in the form of an oxalic acid solid and/or an oxalic acid in solution form. Accordingly, in embodiments, the pests in the beehive can be killed when exposed to one or more of the oxalic acid solid and the oxalic acid in solution form.

The pesticide composition of the disclosure can suitably kill the pests while minimally affecting the vitality of the live bees in the active beehive. In embodiments, at least about 10, 20, 30, 40, 50, or 60% and/or up to about 50%, 60%, 70%, 80% or 100% of the live bees survive after killing the pests by exposure to the formic acid and oxalic acid. For example, in embodiments, at least about 10, 15, 20, 25, 30, 35, 40, 45, 50, 55, 60, 65, 70, 75, 80, 85, 90, 95, or 100% of live bees survive. The live bees in the beehive can include a live queen bee. In embodiments, the queen bee can advantageously survive after killing the pests, such as mites, by exposure to the formic acid and oxalic acid.

In embodiments, at least about 50%, 60%, 70%, or 75% and/or up to about 70%, 75%, 80%, 90% or 100% of the pests initially present in the beehive are killed by exposure to formic acid and oxalic acid. For example, in embodiments, at least about 50, 55, 6, 65, 70, 75, 80, 85, 90, 95, or 100% of the pests that were initially present are killed by exposure to the formic acid and oxalic acid.

Advantageously, the pesticide composition of the disclosure can be modified to provide the most suitable release rate and effectiveness for a variety of environmental conditions. In embodiments, the beehive temperature is in a range from at least about 5, 10, 15, 20, or 25° C. and/or up to about 20, 25, 30, 35 or 40° C., for example about 5, 10, 15, 20, 25, 30, 35, or 40° C. This temperature can correspond to the beehive temperature at the time the pesticide composition is inserted, the time the oligomeric polyester of the composition hydrolyzes, and/or the time at which the live bees transport by contact the polyester and/or any hydrolysis products thereof (e.g., partially hydrolyzed polyester and/or oxalic acid). In embodiments, the relative humidity of the beehive is up to about 80% or 100%, for example at least about 0, 10, 15, 20, 30, 40 or 45% and/or up to about 30, 40, 50, 60, 70, 75, 80, 90, or 100%. This relative humidity can correspond to the beehive humidity at the time the pesticide composition is inserted, the time the oligomeric polyester of the composition hydrolyzes, and/or the time at which the live bees transport by contact the polyester and/or any hydrolysis products thereof (e.g., partially hydrolyzed polyester and/or oxalic acid).

In embodiments, the pesticide composition of the disclosure can be modified, for example by adding and/or removing water and/or free formic acid. These modifications can affect the release rate, that is, the rate of hydrolysis, of the oligomeric polyester. In embodiments, at least about 30, 35, 40, 45, or 50% and/or up to about 40, 50, 60, 70, 80, 90, or 100% of the formic acid capping units initially in the pesticide composition are released as formic acid in a first 14-day period after inserting the pesticide composition into the beehive. For example, in embodiments, about 30% to about 90% or 100% of the formic acid capping units initially in the pesticide composition are released as formic acid in a first 14-day period after inserting the pesticide composition into the beehive. In some embodiments, up to about 90% or about 100% of the formic acid capping units can be released in a first 10-day period after inserting the pesticide composition into the beehive.

This release rate can be modified, as described above and demonstrated in the examples, by adding and/or removing free formic acid from the pesticide composition. In embodiments, only about 30, 40, or 50% and/or up to about 45, 50, 60, 70, or 80% of the total formic acid capping units released as formic acid in the first 14-day period are released in the first 7 days thereof. For example, in embodiments, only 30% or 50% to 70% or 80% of the total formic acid capping units released as formic acid in the first 14-day period are released in the first 7 days thereof. In embodiments, at least 10%, 15%, 20%, 25% 30%, 35% or 40% of the formic acid capping units initially in the pesticide composition are released as formic acid in a second 7-day period subsequent to the first 14-day period after inserting the pesticide composition into the beehive. For example, in embodiments, at least 10% the total formic acid capping units released as formic acid in the first 14-day period are released in the first 7 days thereof. In embodiments, at least 20%, 25%, 30%, 35%, 40%, 45%, or 50% of the formic acid capping units initially in the pesticide composition are released as formic acid in a second 14-day period subsequent to the first 14-day period after inserting the pesticide into the beehive. For example, in embodiments, at least 20% of the formic acid capping units initially in the pesticide composition are released as formic acid in a second 14-day period subsequent to the first 14-day period after inserting the pesticide into the beehive.

### EXAMPLES

### Example 1—Synthesis and Evaluation of the Oligomeric Polyester

The polyester was prepared by reacting oxalic acid with excess glycerol, to provide a branched polyester with glycerol/oxalic acid units in the backbone. The polyester was formed by generally following the illustrative reaction scheme. Although the scheme illustrates chain propagation by reacting the glycerol hydroxyl units at the 1,3-positions, chain propagation likewise can occur by reacting the glycerol hydroxyl units at adjacent 1,2-positions. Further, although the scheme illustrates a free hydroxyl group along the repeating unit backbone, it is understood that the hydroxyl group can be reacted in some repeat units with another oxalic acid unit to provide a branching point in the polyester.

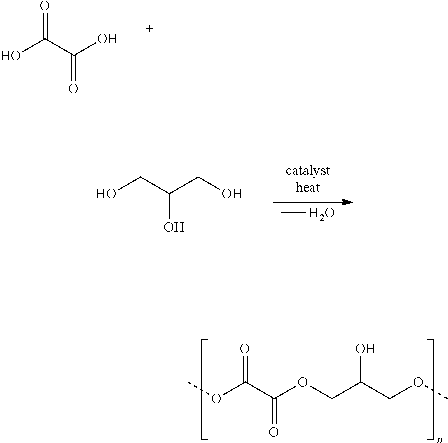

To the resulting polyester, formic acid was chemically bonded to the available OH end groups and free OH backbone groups to provide the oligomeric polyester. Exemplary structures of a linear and branched oligomeric polyester according to the disclosure are provided in FIG. 1, panel (A) and panel (B), respectively. The following examples provide illustrative examples of branched oligomeric polyesters according to the disclosure.

The polyesters, prepared as provided above, were exposed to controlled temperature and humidity environments by enclosure in a closed dessicator at two different, constant temperatures of 75° F. (23.9° C.) and 93° F. (33.9° C.), and a relative humidity (RH) of 74% and 56%, respectively, which was maintained with salt baths. These controlled environments provided a static system, with no airflow, in which to evaluate the degradation of the polyester and the release of miticides (i.e., formic acid and/or oxalic acid). The release of the miticide was monitored by ¹³C-NMR of the polyester at various time points of exposure to the controlled environments. The NMR spectra allowed for the determination of the miticides still remaining in the polymer, whether free (hydrolyzed) or still bound to the polymer.

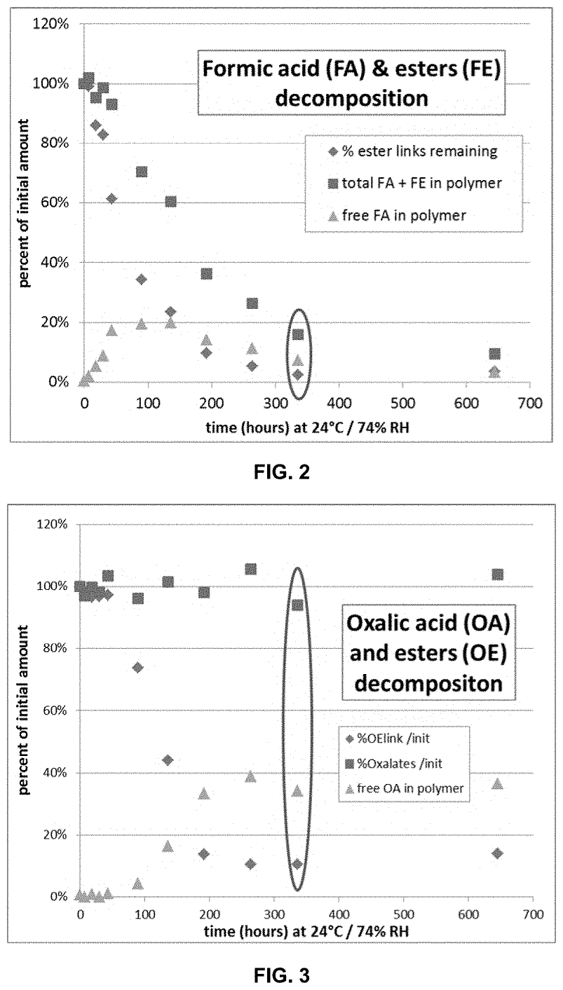

FIG. 2 shows the release of formic acid from the polyester when maintained at 75° F. and 74% RH over a period of about 27 days (˜648 hours). As shown in FIG. 2, the polyester demonstrated timed release of the formic acid, with about 80% release in 14 days (336 hours), and about 90% release in 27 days. Likewise, FIG. 3 shows the release of oxalic acid form the polyester when maintained at 75° F. and 74% RH over a period of about 27 days (˜648 hours). As shown in FIG. 3, the amount of released oxalic acid built up over about 8 to 12 days (˜200-300 hours), at which point it remained relatively constant. The polyester demonstrated a timed release of oxalic acid with about 40% release in 9 days (216 hours).

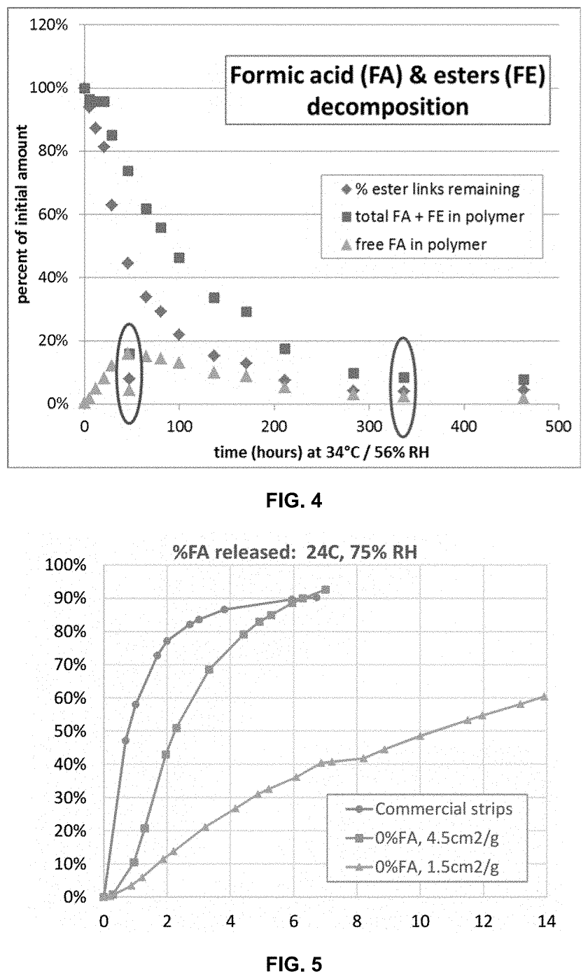

FIG. 4 shows the release of formic acid from the polyester when maintained at 93° F. and 56% RH over a period of about 20 days. As shown, the degradation and release of formic acid was much faster than the polyester maintained at a temperature of 75° F. and 74% RH. In particular, about 80% of the formic acid was released in 8 days (˜192 hours) and about 90% was released in about 12 days (˜288 hours). Furthermore, the release of oxalic acid, not depicted in FIG. 4, was also faster than the polyester maintained at a temperature of 75° F. and 74% RH.

Moreover, without intending to be bound by theory, it is believed that the linear release profile of the formic acid at 93° F. and 56% RH indicated a surface effect (i.e., that surface kinetics applied), in which the rate of release will increase with higher surface area of the polymer.

The polyesters were further evaluated against commercial formic acid strips by containment in a small reactor held in a constant temperature at 75° F. and 75% RH. Humidity was controlled by bubbling nitrogen gas through salt solutions at 1 mL/s into the reactor. Formic acid was collected by sparging the reactor exit gas through a deionized water trap, and quantified by titration.

As shown in FIG. 5 for %formic acid (FA) released as a function of time (days), the oligomeric polyester demonstrated slower release than the commercial formic acid strips. In particular, the commercial formic acid strips released (i.e., lost) 60% of the formic acid within the first day, and nearly 80% within 2.3 days. At the end of a week, 10% of the formic acid remained and was never released from the commercial formic acid strips. The oligomeric polymer according to the disclosure included no added free forming acid (i.e., 0% FA as indicated in the figure) and was applied at two different levels: 4.5 cm²/g (i.e., a relatively thinner layer) and 1.5 cm²/g (i.e., a relatively thicker layer). Advantageously, the oligomeric polymer showed a near linear release of the formic acid, in particular at 1.5 cm²/g, demonstrating a more controlled and delayed release as compared to the commercial strips. These results were consistent when the RH of the system was reduced to 56%.

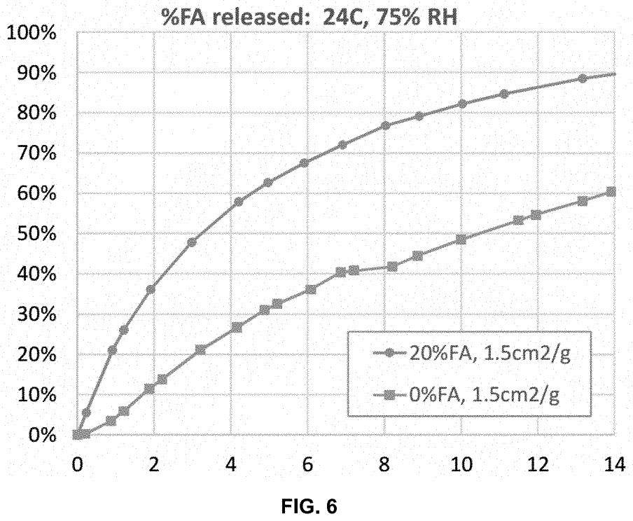

Also within the flow reactor system, the release of formic acid was evaluated when free formic acid was added to the formulations, in addition to the oligomeric polyester. When present, the additional formic acid was added in an amount of 20 wt. % relative to total free formic acid and oligomeric polyester combined. The formulations with and without free formic acid were applied at levels of 1.5 cm²/g. As shown in FIG. 6 for % formic acid (FA) released as a function of time (days), adding free formic acid eliminated the initial period of slow release of formic acid from the polyester. Furthermore, the addition of free formic acid increased the overall release rate of formic acid from the polyester. In particular, it was observed that the time (e.g., days) to complete release of formic acid from the polyester exposed to free formic acid was two to three times shorter than the polyester not exposed to any additional free formic acid.

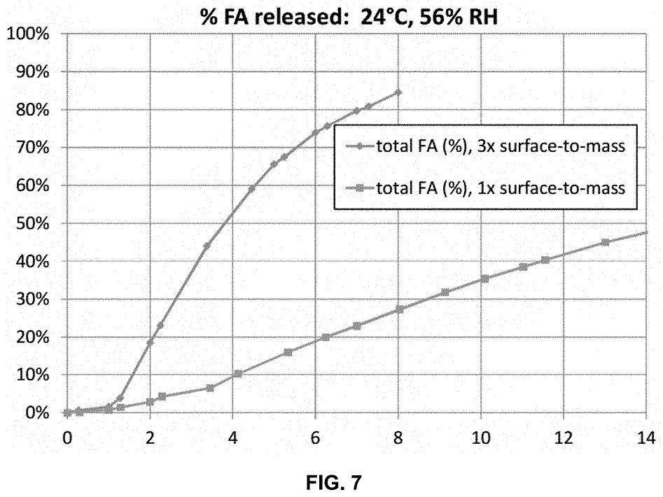

Furthermore, the effect of the surface-to-mass (s/m) ratio was evaluated. As shown in FIG. 7, an increase of three times the s/m ratio resulted in a four to six times increase in the rate of release of formic acid from the polyester. Accordingly, selection or control of the thickness of an applied layer with a desired corresponding surface-to-mass can be used to control release rates in a given use environment.

In summary, Example 1 demonstrates that the rate of release of formic acid from the oligomeric polyesters according to the disclosure remained relatively constant across a variety of environmental conditions such as temperature and humidity. Furthermore, the rate of release of the polymer was significantly increased when the surface to mass ratio and the amount of free formic acid included in the system were increased.

### Example 2—Evaluation of Oligomeric Polyesters in the Field

The oligomeric polyesters were further evaluated in beehives. A branched polyester, akin to that of FIG. 1, panel (B), was prepared. Based on the results shown in Example 1, the polyester was further formulated with 15% free formic acid to provide a quicker release rate in the field. The formulation, containing the polyester and the free formic acid, as well as a control (i.e., commercial formic acid strips), were dosed to Varroa infected beehives in an amount of 350 g. The hives were infected with at least about 1 mite per bee.

The results are shown in Table 1 below. The mite counts were obtained per 300 bees (i.e., half a cup), and were collected using powdered sugar, a 1 minute roll, and a 1 minute shake through mesh.

TABLE 1
Initial Field Results with 15% Free Formic Acid

| | Initial | Final | Percent | | |
|---|---|---|---|---|---|
| | Mites | Mites | Reduction | Bee | Queen |
| Treatment | (0 d) | (12 d) | (%) | Loss | Loss |
| Polyester | 84 | 12 | 86% | “high” | Yes |
| Formulation | | | | | |
| Commercial | 78 | 24 | 69% | “high” | No |
| Formic Acid | | | | | |
| Strips | | | | | |

As can be seen by the data in Table 1, the polyester formulation reduced the mites to about half the level obtained by commercial formic acid strips. The more relevant result is the significantly higher rate of killing mites. In some cases, prior to treatment, hives can be collectively in such poor health from the mite infestation that the queen loss can be unrelated to the particular treatment.

Next, the polyester formulations were tested without the free formic acid to discern whether the release profile of the formic acid from the polyester could be easily controlled as demonstrated in Example 1. The results for these are shown in Tables 2 & 3, below, where for the low initial mites hives (Table 2), no free formic acid was added to the formulation, and for the high initial mites hives (Table 3), 9% formic acid was added to the formulation. A 2×½ dosing means that, since mites were low, only half a dose (about 150 g) was initially used, and then, after a month, the hive was tested for mites and a second half-dose was administered. Thus, Table 2 shows that, when mites are low and no initial “surge” of formic acid is needed, the slow-release polymer can effectively work over many weeks. Similarly, a 1×1 dosing means that a single full dose (about 300 g) was initially applied. Thus, Table 3 shows that when mite counts are initially at dangerously high levels, the miticide at a higher dose can effectively reduce the mite level down to near zero. SS % (300) indicates the mite percentage determined by the Sugar Shake method, assuming 300 bees, which method was used for the data in Tables 2 and 3.

TABLE 2
Field Results of Polyester in Low Initial Mite Hives

| | | Initial Mites | After 1 Month | | | After 2 Months | | |
|---|---|---|---|---|---|---|---|---|
| Treatment | Hive | Sugar | Sugar | Mite | Queen | Sugar | Mite | Queen |
| No. | Dose | Shake | Shake | Drop | Loss | Shake | Drop | Loss |
| 1 | 2 x ½ | 0 | 1 | 72 | N | 0 | 73 | N |
| 2 | 2 x ½ | 1 | 1 | 171 | N | 1 | 211 | N |
| 3 | 2 x ½ | 1 | 1 | 51 | N | 0 | 141 | N |
| 4 | none | — | — | — | — | 33 | — | — |
| 5 | none | — | — | — | — | 42 | — | — |

TABLE 3
Field Results of Polyester in High Initial
Mite Hives (9% Free Formic Acid)

| | | Initial Mites | | | After 5 weeks | | |
|---|---|---|---|---|---|---|---|
| Treatment | Hive | Sugar | SS % | Salt | Sugar | Mite | Queen |
| No. | Dose | Shake | (300) | Water | Shake | Drop | Loss |
| 6 | 1 x 1 | 17 | 6% | 7-9% | 0 | N/A | N |
| 7 | 1 x 1 | 18 | 6% | 7-9% | 0 | N/A | N |

Therefore, Example 2 demonstrates that the oligomeric polyesters of the disclosure can perform equally or better than formic acid strips that are commercially available. Furthermore, the release profile of the oligomeric polyester can be easily adjusted based on field conditions (humidity, temperature, level of hive infestation, etc.) by modifying the amount of free formic acid added to the polyester formulation.

Advantageously, as shown in Table 2, the mite drop in the hives between 1 month to 2 months of exposure to the polyester showed that mites were present in the hives, and that the controlled and steady release of the formic acid and oxalic acid from the polyester was effective even over two months (using two treatments).

### Example 3—Comparative Evaluation of Oligomeric Polyesters in the Field

The oligomeric polyesters were further evaluated in beehives and compared with various controls. A branched polyester, akin to that of FIG. 1, panel (B), was prepared. Treatments according to the disclosure were prepared by dosing 100, 150, 200, 250, or 300 g of oligomeric polyester to an open petri dish, which was then added to a Varroa-infected beehives. Control treatment samples were also added to infested beehives, including a blank (i.e., empty petri dish) and a solvent (i.e., petri dish with polymer residue and water, but no acid). The various treatment samples were initially introduced into infested beehives on day 1 of treatment, and beehives were investigated for degree of infestation at days 1, 21, and 43 after initial placement of the treatment sample.

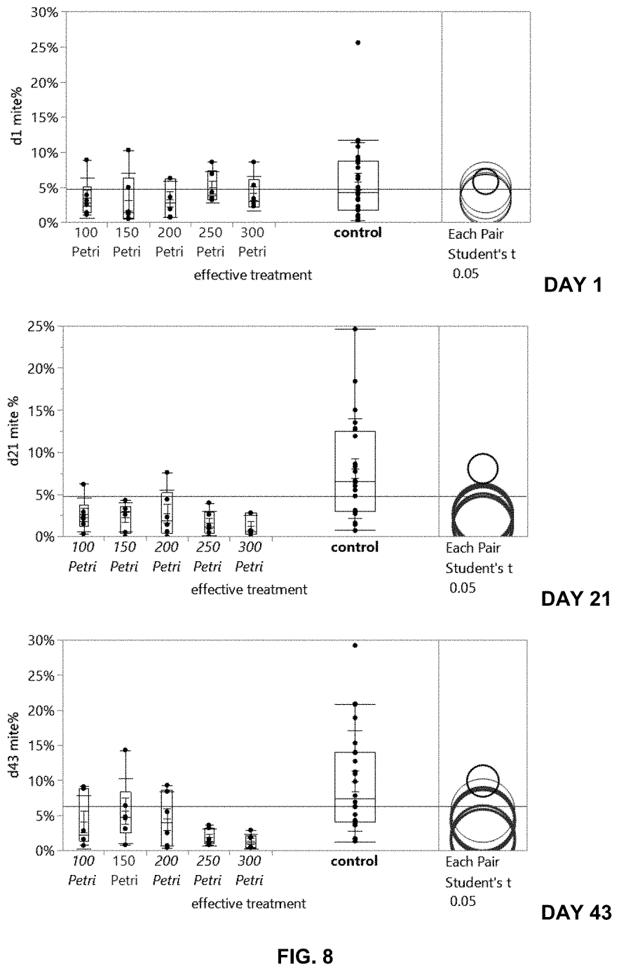

The results are shown in FIG. 8, which present the level of mite infestation (expressed as a percent) as a function of treatment type and at different days after treatment. Treatments according to the disclosure are represented by “X Petri”, where “X” is the amount of oligomeric polyesters (in grams) added to the petri dish that was inserted into the beehive. The control column provides the aggregate results of the various controls above. Initially, at day 1 of treatment, the hives treated with an oligomeric polyester had about 3-5% mite levels, and the control groups had about 5.8% mite levels, with no statistical difference between the groups (top panel). At day 21 after treatment, low doses of oligomeric polyester (about 100-200 g) had mite levels below 2%, higher doses of oligomeric polyester (about 250-300 g) had mite levels of about 1.2-1.5%, thus showing a decrease in mite population (middle panel). In contrast, at day 21 after treatment, mite populations for the control samples rose to about 8% (middle panel). At day 43 after treatment, low doses of oligomeric polyester (about 100-200 g) had mite levels rising back to about 4-5%, while higher doses of oligomeric polyester (about 250-300 g) still had low mite levels below 2% (bottom panel). This shows that the oligomeric polyester can be effective over a long period when applied in a single larger dose, or it likewise can be effective over a long period when applied in multiple smaller doses over time. At day 43 after treatment for the control samples, mite populations continued to rise to about 10% or higher (bottom panel).

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compounds, compositions, articles, methods, and processes are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure. Atty.

What is claimed is:

1. A method for treating an active beehive infested with pests, the method comprising:
(a) providing a pesticide composition comprising a oligomeric polyester comprising:
(i) tri- or higher functional polyol backbone units, (ii) oxalic acid backbone units, and (iii) formic acid capping units;
(b) inserting the pesticide composition into an active beehive infested with pests;
(c) allowing the oligomeric polyester to hydrolyze over time, thereby forming formic acid and oxalic acid as hydrolysis products;
(d) allowing at least one of the oligomeric polyester, a partially hydrolyzed product thereof, and the oxalic acid hydrolysis product to be transported by contact with active bees to locations in the beehive other than that where the pesticide composition was initially inserted;
(e) killing pests in the beehive by exposure to formic acid; and
(f) killing pests in the beehive by exposure to oxalic acid at interior hive surface locations other than that where the pesticide composition was initially inserted.

2. The method of claim 1, wherein the oligomeric polyester has a branched structure.

3. The method of claim 1, wherein the oligomeric polyester has a linear structure.

4. The method of claim 1, wherein the oligomeric polyester is in liquid form.

5. The method of claim 1, wherein the tri- or higher functional polyol is selected from the group consisting of glycerol, pentaerythritol, sorbitol, tris(hydroxymethyl)aminomethane, and combinations thereof.

6. The method of claim 1, wherein the backbone units further comprise at least one of malonic acid, succinic acid, glutaric acid, adipic acid, fumaric acid, sebacic acid, and combinations thereof.

7. The method of claim 1, wherein the active beehive contains live bees therein, and at least 10% of the live bees survive after killing the pests by exposure to formic acid and oxalic acid.

8. The method of claim 7, wherein the live bees in the active beehive include a live queen bee, and the queen bee survives after killing the pests by exposure to formic acid and oxalic acid.

9. The method of claim 1, wherein the pests comprise mites.

10. The method of claim 1, wherein at least 50% of the pests initially present in the beehive are killed by exposure to formic acid and oxalic acid.

11. The method of claim 1, wherein the pesticide composition has about 10 wt. % or less free formic acid.

12. The method of claim 11, wherein the pesticide composition is free from added free formic acid.

13. The method of claim 1, wherein the pesticide composition has about 10 wt. % or less water.

14. The method of claim 1, wherein the oligomeric polyester has a molecular weight in a range from 200 to 5000 g/mol.

15. The method of claim 1, wherein the oligomeric polyester has a viscosity in a range from 100 to 100,000 cP.

16. The method of claim 1, wherein: (i) monomer units corresponding to the polyol are present in the oligomeric polyester in a range of 20-40 wt. %, (ii) monomer units corresponding to the oxalic acid are present in the oligomeric polyester in a range of 20-40 wt. %, and (iii) monomer units corresponding to the formic acid are present in the oligomeric polyester in a range of 30-50 wt.%.

17. The method of claim 1, wherein beehive temperature is in a range from 5° C. to 40° C. during hydrolysis of the oligomeric polyester.

18. The method of claim 1, wherein beehive relative humidity is up to 80% during hydrolysis of the oligomeric polyester.

19. The method of claim 1, wherein the formic acid to which the pests in the beehive are exposed when killed comprises one or more of (i) formic acid vapor and (ii) formic acid in liquid form.

20. The method of claim 1, wherein the oxalic acid to which the pests in the beehive are exposed when killed comprises one or more of (i) oxalic acid solid, and (ii) oxalic acid in solution form.

21. The method of claim 1, wherein the oligomeric polyester is transported by contact with active bees to locations in the beehive other than that where the pesticide composition was initially inserted.

22. The method of claim 1, wherein a partially hydrolyzed product of the oligomeric polyester is transported by contact with active bees to locations in the beehive other than that where the pesticide composition was initially inserted.

23. The method of claim 1, wherein the oxalic acid hydrolysis product is transported by contact with active bees to locations in the beehive other than that where the pesticide composition was initially inserted.

24. The method of claim 1, wherein 30% to 90% of the formic acid capping units initially in the pesticide composition are released as formic acid in a first 14-day period after inserting the pesticide composition into the beehive.

25. The method of claim 24, wherein only 30% to 70% of the total formic acid capping units released as formic acid in the first 14-day period are released in the first 7 days thereof.

26. The method of claim 24, wherein at least 10% of the formic acid capping units initially in the pesticide composition are released as formic acid in a second 7-day period subsequent to the first 14-day period after inserting the pesticide composition into the beehive.

27. The method of claim 24, wherein at least 20% of the formic acid capping units initially in the pesticide composition are released as formic acid in a second 14-day period subsequent to the first 14-day period after inserting the pesticide composition into the beehive.
